(19) United States
(12) Patent Application Publication
(10) Pub. No.: US 2003/0127984 A1
(43) Pub. Date: Jul. 10, 2003

(54) Capillary discharge plasma display panel with field shaping layer

(75) Inventors: Dae-il Kim, Rivervale, NJ (US); Steven Kim, Harrington Park, NJ (US); William Kokonaski, Harbor, WA (US)

Correspondence Address: MORGAN LEWIS & BOCKIUS LLP, 1111 PENNSYLVANIA AVENUE NW, WASHINGTON, DC, 20004, US

(73) Assignee: Plasmion Displays, LLC

(21) Appl. No.: 10/040,939

(22) Filed: Jan. 9, 2002

(51) Int. Cl. H01J 17/49

(52) U.S. Cl. 313/586

(57) ABSTRACT

A capillary discharge plasma display panel with a field shaping layer is disclosed in the present invention. More particularly, a capillary discharge plasma display panel includes first and second substrates, at least one first electrode on the first substrate, a first dielectric layer on the first electrode including the first substrate, at least one second electrode on the second substrate, a second dielectric layer on the second electrode including the second substrate, wherein the second dielectric layer has at least one capillary discharge site corresponding to each second electrode, thereby generating a continuous plasma discharge from the capillary discharge site, a plurality of discharge spaces between the first and second dielectric layers, and at least one third electrode in the second dielectric layer for concentrating the continuous plasma discharge in the capillary discharge site.

### BACKGROUND OF THE INVENTION

1. Field of the Invention

The present invention relates to a plasma display panel, and more particularly, to a capillary discharge plasma display panel with a field shaping layer. Although the present invention is suitable for a wide scope of applications, it is particularly suitable for achieving high efficiency in the capillary discharge plasma display panel (CDPDP).

2. Discussion of the Related Art

A plasma display panel (PDP) has been the subject of extensive research and development in the display industry because it can be realized as a thin and large sized flat panel device. Both AC and DC-operated plasma display panel structures have been developed in the PDP.

The DC-operated PDP employs DC electrodes that are in direct contact with gas, but has to employ current limiting devices such as a resistor in the drive circuit or the discharge cell to prevent an excessive current flow when the gas discharges. In order to confine the discharge area within a pixel, dielectric barriers are positioned between the pixel and prevent the cross talk due to the spread of the ionized gas.

As well known, a dielectric layer is the most commonly used insulating layer that prevents destructive arc discharge in the AC plasma display panel. An expanded respective view of a conventional coplanar barrier type AC plasma display panel is illustrated in FIG. 1.

As shown in FIG. 1, the conventional barrier type AC PDP includes front and rear glass substrates 11 and 12 that enclose a discharge gas (not shown) filled in a discharge space 13. A plurality of bus electrodes 14 and corresponding ITO electrodes 15 are formed on the front glass substrate 11. Both the bus electrodes 14 and the ITO electrode 15 are completely covered with a first dielectric layer 16. Similarly, a plurality of address electrodes 17 are formed on the rear glass substrate 12 and are also completely buried by a second dielectric layer 18 in order to prevent arc discharge on the surface of the address electrodes 17.

Further, a plurality of barrier ribs 19 define the discharge space 13. A phosphor layer 20 is formed on the inner walls of the barrier ribs 19, so that the generated UV light is converted into visible light.

However, the conventional barrier type AC PDP generates low-density plasma, resulting in low brightness and a slow response time due to a long discharge time on the dielectric wall.

### SUMMARY OF THE INVENTION

Accordingly, the present invention is directed to a capillary discharge plasma display panel with a field shaping layer that substantially obviates one or more of the problems due to limitations and disadvantages of the related art.

Another object of the present invention is to provide a capillary discharge plasma display panel with a field shaping layer that provides high efficiency in the capillary discharge.

Additional features and advantages of the invention will be set forth in the description that follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a capillary discharge plasma display panel includes first and second substrates, at least one first electrode on the first substrate, a first dielectric layer on the first electrode including the first substrate, at least one second electrode on the second substrate, a second dielectric layer on the second electrode including the second substrate, wherein the second dielectric layer has at least one capillary discharge site corresponding to each second electrode, thereby generating a continuous plasma discharge from the capillary discharge site, a plurality of discharge spaces between the first and second dielectric layers, and at least one third electrode in the second dielectric layer for concentrating the continuous plasma discharge in the capillary discharge site.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is an expanded perspective view of a conventional coplanar barrier type AC plasma display panel;

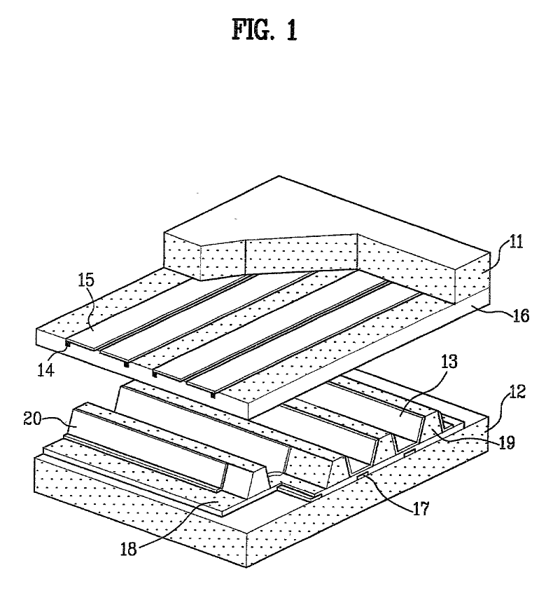

FIG. 2 is a schematic perspective view of a front substrate of a capillary discharge plasma display panel with a field shaping layer according to the present invention; and

FIG. 3 is a cross-sectional view of the front substrate of the capillary discharge plasma display panel with the field shaping layer taken along with line III-III of FIG. 2.

### DETAILED DESCRIPTION OF THE ILLUSTRATED EMBODIMENTS

Reference will now be made in detail to the illustrated embodiments of the present invention, examples of which are illustrated in the accompanying drawings.

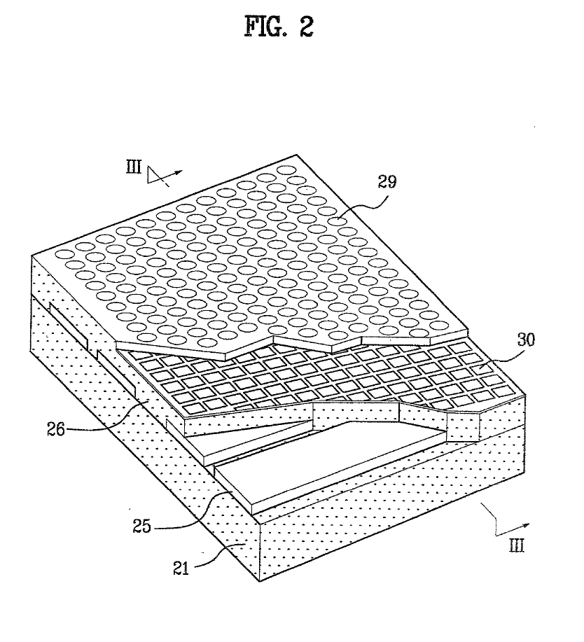

FIG. 2 is a schematic perspective view of a front substrate of a capillary discharge plasma display panel with a field shaping layer according to the present invention.

As shown in FIG. 2, a capillary discharge plasma display panel with a field shaping layer includes a glass substrate 21, at least one first electrode 25 on the glass substrate 21, and a dielectric layer 26 covering the first electrode 25 including the glass substrate 21.

In the dielectric layer 26, a plurality of capillary discharge sites 29 are formed therein to generate continuous plasma discharge.

The first electrode 25 on the glass substrate 21 is transparent as to visible light. For example, the first electrode 25 may be formed of indium tin oxide (ITO). Also, the dielectric layer 26 is transparent as to visible light. The dielectric layer 26 may be formed of lead oxide (PbO) in the present invention.

For AC driving, the dielectric layer 26 is formed to completely cover the first electrode 25, so that the first electrode 25 is separated from discharge spaces (not shown).

In the dielectric layer 26, a field shaping layer 30 is formed therein. The field shaping layer 30 may be either floated or biased. When a bias voltage is applied to the field shaping layer 30, about a half value of the sustain voltage is applied. Thus, an electromagnetic noise can be reduced and a coupling effect is also reduced between the electrodes.

The field shaping layer 30 may be formed of either one body layer or a plurality of isolated layers having any kind of shapes. The isolated layers may minimize a coupling effect between the electrodes. The field shaping layer 30 is located around the capillary discharge sites 29, so that it does not have to be aligned with the capillary discharge sites 29.

The field shaping layer 30 is formed of a transparent conductor, such as indium tin oxide (ITO) or tin oxide (SnO₂). The field shaping layer 30 is designed to have a high resistivity of at least about 100 Ω/square, so that a parasitic capacitance or a stray capacitance can be reduced in the present invention. As a result, a power consumption is minimized.

A detailed structure of a rear substrate is not illustrated in the present invention. Similar to the rear substrate of the conventional coplanar type AC plasma display panel, on the glass substrate, a plurality of address electrodes are formed thereon. A dielectric layer covers the address electrodes including the glass substrate. A pair of barrier ribs on the dielectric layer define each discharge space. On the inner walls of the barrier ribs, a UV-visible conversion layer such as phosphor is formed thereon. Additionally, a protective layer such as magnesium oxide may also be formed on both of the dielectric layers of the front and rear substrates.

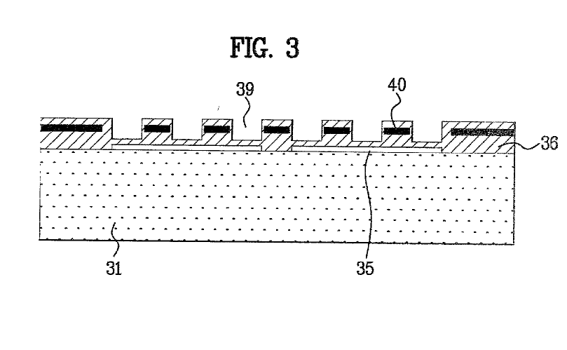

FIG. 3 is a cross-sectional view of a front substrate of the capillary discharge plasma display panel with the field shaping layer taken along with line III-III of FIG. 2.

As shown in FIG. 3, at least one capillary discharge site 39 is formed over a metal electrode 35. The capillary discharge site 39 does not expose any portion of the metal electrode, so that the vertical end of the capillary discharge site 39 is separated by a dielectric layer 36. For example, a diameter of the capillary discharge site 39 may be in the range of about 20 to 1000 μm. A depth of the capillary discharge site 39 may be in the range of about 10 to 500 μm.

A discharge takes place in the capillary discharge site as well as at the dielectric surface outside the capillary discharge sites 39. However, a discharge efficiency for the capillary discharge sites is much higher than the discharge efficiency at the dielectric surface outside the capillary discharge sites 39. By adopting a field shaping layer 40 in the dielectric layer around the capillary discharge sites 39, a potential over the electrode 35 is uniformly distributed. Thus, the capillary discharge is optimized in the present invention.

It will be apparent to those skilled in the art that various modifications and variations can be made in the capillary discharge plasma display panel with a field shaping layer without departing from the spirit or scope of the inventions. Thus, it is intended that the present invention covers the modifications and variations of this invention provided they come within the scope of the appended claims and their equivalents.

What is claimed is:

1. A capillary discharge plasma display panel, comprising:
first and second substrates;
at least one first electrode on the first substrate;
a first dielectric layer on the first electrode including the first substrate;
at least one second electrode on the second substrate;
a second dielectric layer on the second electrode including the second substrate, wherein the second dielectric layer has at least one capillary discharge site corresponding to each second an electrode, thereby generating a continuous plasma discharge from the capillary discharge site;
a plurality of discharge spaces between the first and second dielectric layers; and
at least one third electrode in the second dielectric layer for concentrating the continuous plasma discharge in the capillary discharge site.

2. The plasma display panel according to claim 1, wherein the second electrode includes an indium tin oxide layer.

3. The plasma display panel according to claim 1, wherein the second dielectric layer includes a lead oxide layer.

4. The plasma display panel according to claim 1, wherein the at least one third electrode acts as a field shaping layer.

5. The plasma display panel according to claim 1, wherein the at least one third electrode is applied with a bias voltage.

6. The plasma display panel according to claim 5, wherein the bias voltage is about a half value of a sustain voltage.

7. The plasma display panel according to claim 5, wherein the at least one third electrode is floated.

8. The plasma display panel according to claim 1, wherein the at least one third electrode is formed of a transparent conductor.

9. The plasma display panel according to claim 8, wherein the transparent conductor is formed of one of indium tin oxide (ITO) and tin oxide (SnO₂).

10. The plasma display panel according to claim 8, wherein the transparent conductor has a resistivity of at least 100 Ω/square.

11. The plasma display panel according to claim 1, wherein the at least one third electrode is formed of a plurality of isolated layers.

12. The plasma display panel according to claim 1, wherein the at least one third electrode is formed of a single body layer.
